(19) United States
(12) Patent Application Publication
(10) Pub. No.: US 2014/0208105 A1
(43) Pub. Date: Jul. 24, 2014

(54) Automated Content Signing for Point-of-Sale Applications in Fuel Dispensing Environments

(71) Applicant: Gilbarco, S.r.I., Firenze (IT)

(72) Inventor: Giovanni Carapelli, High Point, NC (US)

(73) Assignee: Gilbarco, S.r.I., Firenze (IT)

(21) Appl. No.: 14/161,024

(22) Filed: Jan. 22, 2014

Related U.S. Application Data
(60) Provisional application No. 61/755,578, filed on Jan. 23, 2013.

(51) Int. Cl. H04L 29/06

(52) U.S. Cl. CPC H04L 63/0428
USPC 713/168

(57) ABSTRACT

A system and method for obtaining manufacturer-signed content for use with manufacturer equipment is provided. Content is obtained at a merchant device for executing or presenting on manufacturer equipment. A signature is generated for the content based on a private key. The merchant device transmits the content and signature to a manufacturer server. The manufacturer server decrypts and authenticates the signature based on the private key or a corresponding public key. If authenticated, the manufacturer server re-signs the content with a manufacturer signature that allows the content to be presented or executed on manufacturer equipment.

### PRIORITY CLAIM

The present application claims the benefit of U.S. patent application No. 61/755,578, filed Jan. 23, 2013, and entitled “AUTOMATED CONTENT SIGNING FOR POINT-OF-SALE APPLICATIONS IN FUEL DISPENSING ENVIRONMENTS,” the disclosure of which is hereby incorporated by reference as if set forth verbatim herein in its entirety and relied upon for all purposes.

### TECHNICAL FIELD

The subject matter described herein relates generally to fuel dispensers, and more specifically to managing content employed by fuel dispensers.

### BACKGROUND

Retail fueling dispensers offer inputs for customer data in routine and specific manners, such as answering of scripted yes/no questions, credit card swiping, zip code entry, etc. While this facilitates control over reception and further communication of the customer data, the dispensers are unable to utilize different business applications or services desired by retail merchants for possibly increasing revenue, maintaining loyalty, and offering a unique user experience while maintaining or guaranteeing a level of security mandated by governing bodies, such as payment card industry (PCI) security counsel, Europay, Mastercard, Visa (EMV), etc. Introduction of such applications or services at the fuel dispensers may compromise security of customer data due to the ability of such applications or services to possibly access the same inputs currently utilized at the dispensers for payment or other transactions.

In this regard, authentication of the applications or services prior to allowing execution at a fuel dispenser may be desired to allow control over which applications or services are entitled to execute. Authentication can be performed by allowing only applications or services signed by specified entities to execute on the fuel dispenser. In particular, components of the fuel dispenser are configured to verify a signature of an application uploaded thereto against one or a database of allowed signatures before permitting execution. The fuel dispenser typically requires applications or services to be signed by a signature of the manufacturer in order to execute on the fuel dispenser. Thus, the manufacturer is responsible for reviewing and testing third-party applications developed for the fuel dispenser to ensure proper functionality, proper security, etc., and signing the applications for use on the fuel dispenser. This can be an onerous undertaking on the part of the fuel dispenser manufacturer as volume of applications and application developers increase. Moreover, merchants that employ the dispenser may desire to use different applications with fuel dispensers deployed onsite.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein are directed to automated content signing for point-of-sale applications in certain environments. Content (e.g., applications, services, etc.) can be automatically signed by a manufacturer of certain equipment based on determining that the content is received from an authenticated source, where the authenticated source can include a merchant that employs the equipment at one or more sites. Such automated signing by the manufacturer places the onus to verify authenticity or trustworthiness of the content, or respective sources, on the merchant. For example, the merchant can sign content it deems trusted with a signature provided by the manufacturer, and send the signed content to the manufacturer for separate authentication. The manufacturer can automatically re-sign content based on authenticating the signature of the merchant to allow use with the equipment produced by the manufacturer at the merchant site. The merchant can transfer the manufacturer-signed content to its equipment to allow usage thereof.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIG. 1 is an aspect of an example system for automatically signing content with a manufacturer signature for use with manufacturer equipment.

FIG. 2 is an aspect of an example system for obtaining manufacturer-signed content.

FIG. 3 is an aspect of an example system for signing content with a manufacturer signature.

FIG. 4 is an aspect of an example methodology for obtaining manufacturer-signed content.

FIG. 5 is an aspect of an example methodology for providing manufacturer-signed content.

FIG. 6 is an aspect of an example system in accordance with aspects described herein.

FIG. 7 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to automated signing of content for use in an environment involving potentially multiple responsible parties. In one example, content can be signed to allow for execution thereof on certain equipment, such as a vending machine, fuel dispenser, etc. In this regard, a manufacturer of the equipment can sign the content according to one or more valid signatures specified in the equipment. The manufacturer, however, may not desire to approve all applications for potential execution on the equipment, may not be able to directly inspect and approve all applications (including those developed by third parties), etc., and can thus charge a merchant that uses the equipment with this responsibility. In one example, the manufacturer can provide the retail merchant with another signature that facilitates automated content signing at the manufacturer where the content is originally signed with the signature provided to the merchant. This can be accomplished, in one example, by the manufacturer providing the merchant with an additional automated signing device, as described herein, based on an additional merchant signature for authentication, which can ultimately indicate the compliance of the application or other content.

For example, the merchant can obtain content it desires to execute on the manufacturer equipment and can sign the content with the provided signature. For example, this can include using an automated signing device received from the manufacturer. The merchant can provide the signed content to the manufacturer of the equipment. The manufacturer verifies the signature of the signed content as related to the merchant, for example, and can accordingly automatically re-sign the content with the manufacturer's signature that allows the equipment to utility the content. The manufacturer can provide the manufacturer-signed content to the merchant, and the merchant can transfer the content to the equipment for use therewith. In this example, the equipment can execute the content based on verifying the manufacture signature. Thus, the process for authenticating content can include a dual level signature: the merchant signature to prove the merchant identity to the manufacturer; and the manufacturer signature to prove that an authorized merchant has taken responsibility of guaranteeing the functionality, security, etc. of the content. Signature is used herein to describe a digital or electronic signature used to authenticate and verify authenticity of associated content.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

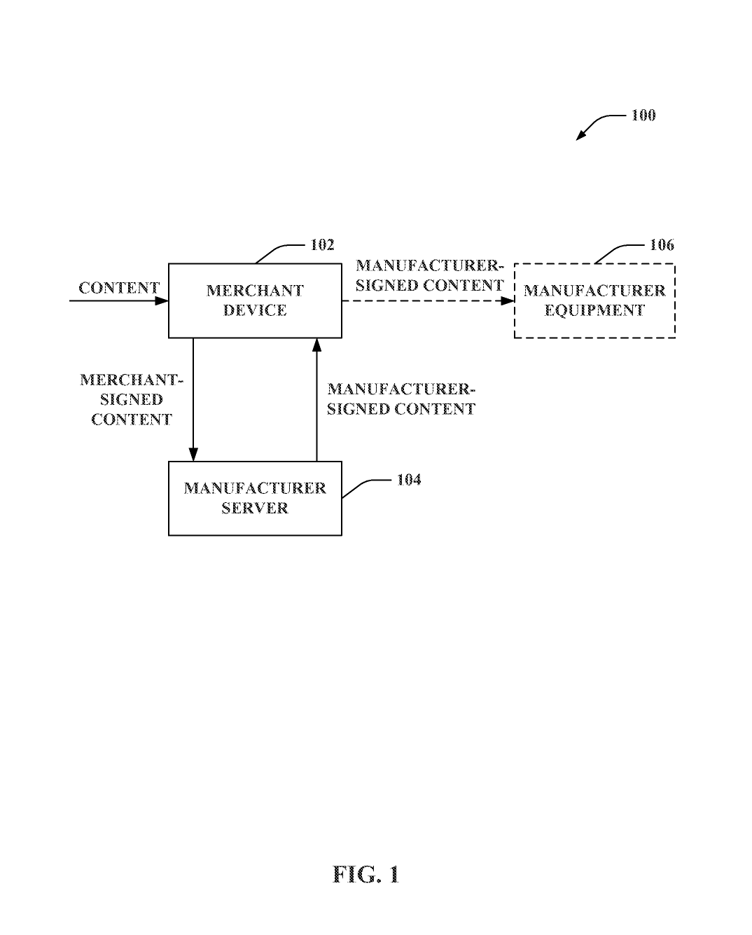

FIG. 1 illustrates an example system 100 for automatically signing content for usage with certain equipment. System 100 includes a merchant device 102 for signing content with a signature assigned to a merchant, a manufacturer server 104 for automatically signing merchant-signed content with a signature of the manufacturer, and optionally manufacturer equipment 106 that can receive and present or execute content signed with a signature of the manufacturer. It is to be appreciated that the merchant device 102 and manufacturer server 104 can be located remotely from one another, and can communicate over one or more networks (e.g., the Internet). In addition, in an example, manufacturer equipment 106 can be located at the merchant. In one specific example, the manufacturer equipment 106 can correspond to a vending machine, fuel dispenser, or other transactional device, a portion thereof (e.g., a payment terminal), etc. Moreover, in an example, the manufacturer equipment 106 can include multiple devices (e.g., multiple vending machines, fuel dispensers, etc.), and merchant device 102 can communicate content to at least a portion of the multiple devices.

In an example, the merchant device 102 can comprise a computer, processor, or other electronics operable to sign content with a merchant signature. The merchant device 102 can generate a private key from which the signature is generated, and provide the private key or a corresponding public key to the manufacturer server 104. In another example, the merchant device 102 can utilize a private key known to the manufacturer server 104 for generating the signature. In one example, the merchant device 102 can be an anti-tampering unit provided to the merchant by the manufacturer associated with manufacturer server 104 and manufacturer equipment 106. In this regard, the manufacturer can program the anti-tampering unit with the private key for generating the signature used to authenticate content from the merchant. In this example, merchant device 102 can include anti-tampering electronics, such as tamper detecting and/or related event causing mechanisms. For instance, merchant device 102 can include switches that are activated when the merchant device 102 is assembled, such that disassembly thereof can cause deactivation of the switches, which can result in deletion of any private keys, notification of tampering to the merchant or manufacturer, etc. Similarly, the anti-tampering electronics can include wire mesh to detect removal or destruction of certain interfaces, etc.

In any case, merchant device 102 can sign certain content with a merchant signature, which can be generated based on the private key and the content, for authentication by manufacturer server 104. For example, the merchant device 102 can receive the content from one or more sources (e.g., at the direction of an operator), such as from an input device, a local or remotely located data repository, and/or the like. In this regard, for example, the content can be uploaded to the merchant device 102 for the signing process. Merchant device 102 can provide the content to manufacturer server 104. In one example, merchant device 102 can encrypt the content prior to providing to the manufacturer server 104. Moreover, for example, merchant device 102 can establish a secure link with the manufacturer server 104 for communicating the content thereto. Manufacturer server 104 can obtain the signed content and can authenticate the signature as a signature corresponding to the merchant (or merchant device 102). For example, the signature can have been provided to the manufacturer server 104 by the merchant device 102 or another device and indicated as relating to the merchant (or merchant device 102), or the signature may be assigned to the merchant (or merchant device 102) by the manufacturer server 104, etc. In one example, authentication can include decrypting the signature using the private key or corresponding public key at the manufacturer server 104, and verifying that the decrypted signature is authentic.

Based at least in part on verifying that the signature corresponds to the merchant or merchant device 102, manufacturer server 104 can automatically re-sign the content with a signature of the manufacturer. Manufacturer server 104 can provide the manufacturer-signed content to the merchant device 102. The content can be obtained from the merchant device 102 for uploading to manufacturer equipment, such as equipment 106. In another example, merchant device 102 can transfer the manufacturer-signed content directly to manufacturer equipment 106. In any case, manufacturer equipment 106 executes or otherwise presents the content based on verifying the manufacturer signature as authentic. For example, the automated signing of content on behalf of the manufacturer based on authenticating the merchant signature can result in the merchant being ultimately responsible for verifying the proper functioning, security, or general trustworthiness of the content or source thereof. Thus, the manufacturer need not test and approve all content received for use with its manufacturer equipment 106.

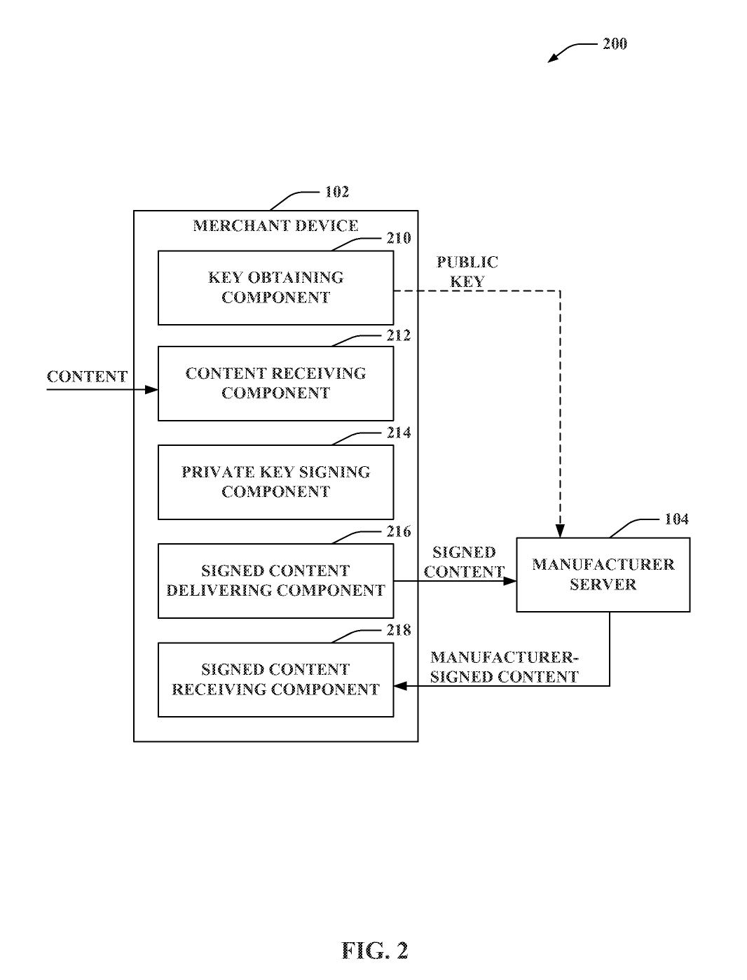

FIG. 2 illustrates an example system 200 for providing signed content to a manufacturer for automated signing. System 200 includes a merchant device 102 for signing content to be authenticated and re-signed by a manufacturer for execution or presentation on equipment of the manufacturer, and a manufacturer server 104 for verifying (e.g., authenticating) and re-signing the content from the merchant device 102. Merchant device 102 can include a computer, processor, or other electronics configured to obtain and sign content for executing or presenting on manufacturer equipment. In one example, the merchant device 102 can be provided by the manufacturer related to manufacturer server 104, as described further herein.

Merchant device 102 can include a key obtaining component 210 for retrieving or otherwise generating a security key for generating a signature for associating with received content, a content receiving component 212 for obtaining content to sign or otherwise associate with a signature for execution or presentation on manufacturer equipment, and a private key signing component 214 for associating the content with the signature. For example, associating the content with the signature can include signing the content by applying the security key to the content or related data to generate the signature. Merchant device 102 also includes a signed content delivering component 216 for providing signed content (e.g., the content and the associated generated signature) to a manufacturer server, and a signed content receiving component 218 for obtaining manufacturer-signed content from the manufacturer server.

According to an example, content receiving component 212 obtains content to be executed on manufacturer equipment, which can be leased or otherwise obtained by the merchant. Content receiving component 212 can obtain the content from a local or remote source, a storage device or other memory, a database, etc. In one example, depending on specifications of the merchant device 102, content receiving component 212 may receive the content only from certain sources, such as certain identified remote sources (e.g., identified using secure file transfer protocol (FTP) or other secure transfer mechanisms), certain hardware sources (e.g., a removable storage device, such as a flash drive), one or more input devices, etc. The content can include one or more applications, services, web pages, etc. developed by the merchant, a third party, or other source for which the merchant is charged with verifying proper function, security, general trustworthiness, etc.

Private key signing component 214 can generate a signature for the content based at least in part on a private key assigned to the merchant. For example, key obtaining component 210 can obtain the key to use in generating the signature. Key obtaining component 210, in this regard, can generate the private key and provide the private key or a corresponding public key (e.g., in an asymmetric key pair, such as a Rivest, Shamir, Adleman (RSA) or other key pair) to manufacturer server 104 for verifying the signature, decoding the content, and/or the like. In another example, manufacturer server 104 can generate the private key and/or asymmetric key pair for the merchant device 102 and provide the private key thereto, which is received by key obtaining component 210, while locally storing the private key or corresponding public key at manufacturer server 104. In yet another example, the manufacturer provides the merchant device 102 to the merchant for the purpose of signing content to be automatically signed by the manufacturer. In this example, the manufacturer can provision the merchant device 102 with the private key before providing the merchant device 102 to the merchant, while storing a corresponding key (e.g., within manufacturer server 104 or a component accessible by manufacturer server 104).

In any case, key obtaining component 210 obtains the private key, and private key signing component 214 accordingly generates the signature for the content. For example, generating the signature can include using a signing algorithm to generate the signature based on the private key and the content and/or otherwise associates the content with the private key. In an example, private key signing component 214 can create a hash of at least a portion of the content, and can encrypt the hash using the private key to generate the signature. The manufacturer server 104 can use this hash in comparing the decrypted key to the content, as described further herein.

Signed content delivering component 216 can provide the signed content, which can include the content and its related signature generated using the private key, a package of the content and signature, etc., to the manufacturer server 104. As described, this can be a remote communication of the content and signature, as the manufacturer server 104 can be located remotely and reached via one or more networks between the merchant device 102 and manufacturer server 104. Additionally, in this regard, signed content delivering component 216 can utilize one or more security measures to ensure secure communication of the content and signature to manufacturer server 104. For example, signed content delivering component 216 can establish a secure link with the manufacturer server 104. This can include initiating a public-key infrastructure (PKI) session with the manufacturer server. The PKI session can include mutual PKI authentication between the merchant device 102 and manufacturer server 104, for example, where each can verify identity of the other based on a relevant RSA or other key pair.

In one example, the secure link is established using secure sockets layer (SSL) or other cryptographic protocol, after which or during which the mutual PKI authentication can occur between merchant device 102 and manufacturer server 104. For example, signed content delivering component 216 can utilize a received or otherwise provisioned public key of the manufacturer server 104 to authenticate a communication therefrom encoded with a private key of the manufacturer server 104. Correspondingly, signed content delivering component 216 can encode a communication for transmission to the manufacturer server 104 using a private key for which the manufacturer server 104 knows the corresponding public key to complete the mutual PKI authentication for the secure link. Once the secure link is established, signed content delivering component 216 can transmit the content and signature to the manufacturer server 104. It is to be appreciated that this key pair can be the same as the key pair relating to the signature, in one example, and/or can be provisioned between the merchant device 102 and manufacturer server 104 using one or more of the mechanisms described for the key pair relating to the signature.

In another example, signed content delivering component 216 can further encrypt the content, signature, and/or a package including the content and signature prior to communicating over the secure link to the manufacturer server 104. In one example, such a package can include other information as well, such as an identity of the merchant. This can be performed using the private key obtained by key obtaining component 210 for generating the signature or another key provided to, received from, or provisioned by the manufacturer. In another example, this can be performed using another key pair, or a private key shared by the merchant device 102 and manufacturer server 104 (e.g., triple data encryption standard (3DES), advanced encryption standard (AES), or similar key, etc.).

Manufacturer server 104 receives the signed content and can prove the authenticity by verifying the signature, as described further herein. Manufacturer server 104 then re-signs the content with a signature of the manufacturer where the authenticity is verified. This can include generating another signature based on a private key of the manufacturer and including the signature with or otherwise signing the content. Manufacturer server 104 communicates the content and manufacturer signature, or a package including the content and manufacturer signature, to merchant device 102, which is received by the signed content receiving component 218. It is to be appreciated that the content can still be signed by, or associated with, the merchant signature as well (e.g., with the manufacturer signature applied to the merchant-signed content), or the merchant signature can be removed or replaced by the manufacturer signature. Signed content receiving component 218 can subsequently provide the manufacturer-signed content to a source from which the content is originally received by content receiving component 212 (e.g., a remote source, a flash drive, etc.). In another example, signed content receiving component 218 can provide the manufacturer-signed content to manufacturer equipment (e.g., by downloading the content and manufacturer signature thereto) to allow the content to be presented or executed on the manufacturer equipment. In this regard, as described further herein, the manufacturer equipment can be configured to verify authenticity of the content based on the manufacturer signature (and/or the merchant signature if included).

In one specific example, merchant device 102, where provided by the manufacturer of the equipment or otherwise related to manufacturer server 104, can include an anti-tampering unit provided by the manufacturer. This allows the manufacturer to assume content received from the merchant device 102 is in fact intended to be signed by the manufacturer, and is not content provided by a unintended party that may have tampered with the merchant device 102. For example, merchant device 102 can be provided to a merchant upon signing a contract with the manufacturer for use of the equipment, and can include various security measures to prove authenticity of content received therefrom. For instance, key obtaining component 210 can obtain or generate the private key subject to authentication of an entity using the merchant device 102 to sign content. In one example, a password can be input by a user of the merchant device 102 to enable key obtaining component 210 to obtain or generate the private key. In addition, for example, the merchant device 102 can allow input of a physical secure token, such as a chip card where merchant device 102 includes a chip card reader. In this example, verification of the chip card by the reader (e.g., alone or along with other measures, such as entry of an associated password) can result in activating the signing ability of private key signing component 214 using the private key from key obtaining component 210. For example, such chip cards, passwords, or other credentials can be provided or otherwise initialized, activated, etc. by the manufacturer that provides the merchant with the anti-tampering unit. Thus, if the anti-tampering unit detects tampering, it can disable the signing ability (e.g., by disabling the chip cards, deleting passwords or other credentials from a secure memory of merchant device 102, etc.).

For example, using an authorization process for a user of the merchant device 102 to activate ability to sign content allows the private key to remain undisclosed within the merchant device 102. In addition, using a chip card can ensure only one person can activate the signing process. Thus, for example, authorization of the user at the merchant device 102 can include validating a username and/or password input, detecting presence or insertion of a chip card and/or verifying authorization data stored on the chip card, a combination thereof, or substantially any authorization mechanism, where the authorization mechanism can be challenged-based such to accept and verify credentialed input of a user. When the user is authorized by key obtaining component 210, key obtaining component 210 obtains the private key for signing content. In one example, the private key, or a portion thereof, may exist on the chip card. Content receiving component 212 can then obtain content for signing. Where the merchant device 102 is an anti-tampering unit, for example, the unit can include a port to receive a flash drive or other storage that can store content so the internal components of the merchant device 102 are not altered or otherwise compromised, and the content receiving component 212 can obtain the content therefrom. In other examples, merchant device 102 can obtain content from a remote source, where the source can be verified, as described, such as via secure FTP or other secure transfer mechanism. Private key signing component 214 generates a signature for the content using at least the private key, and signed content delivering component 216 can transmit the content and signature to manufacturer server 104, which can include encrypting the content and signature, communicating over a secure link, etc., as described above.

In addition, it is to be appreciated that merchant device 102 can log one or more of the described transactions (e.g., receiving content, authorizing a user to sign content, obtaining the key, generating the key, signing content, providing signed content to the manufacturer server 104, receiving signed content from the manufacturer server 104, etc.). This can allow for auditing of the merchant device 102, in one example, to recall content provided by the merchant device 102 for signing at the manufacturer.

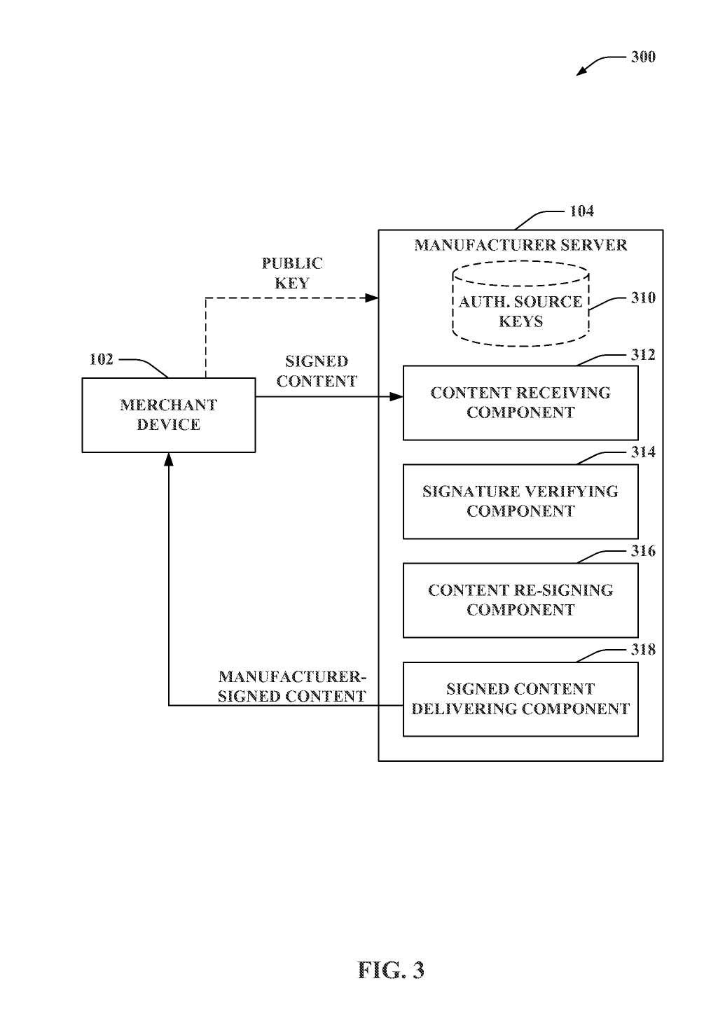

FIG. 3 illustrates an example system 300 for automatically signing content from a merchant device based on verifying a signature of the content. System 300 includes a merchant device 102 for providing signed content to be signed by a manufacturer for operation on manufacturer equipment, and a manufacturer server 104 for receiving signed content from a merchant device and automatically re-signing the signed content based at least in part on authenticating a signature of the signed content. Manufacturer server 104, as described, can include a computer, processor, or other electronics configured to obtain signed content from a device and provide manufacturer-signed content in response.

Manufacturer server 104, in an example. can include a repository of authenticated source keys 310, a content receiving component 312 for obtaining signed content from a merchant device, and a signature verifying component 314 for determining whether a signature provided for the content is authentic. Manufacturer server 104 additionally includes a content re-signing component 316 for signing the content with a signature of a manufacturer to allow the content to be executed or presented on manufacturer equipment (e.g., where the manufacturer equipment is configured to verify the signature as a condition to presenting/executing the content), and a signed content delivering component 318 for providing the manufacturer-signed content to the merchant device.

According to an example, content receiving component 312 can obtain signed content from the merchant device 102. In one example, merchant device 102 and content receiving component 312 can establish a secure link, as described (e.g., using SSL or other secure protocol along with a mutual PKI authentication or similar verification). In addition, content receiving component 312 can receive the content, signature, a package including the content and signature, etc. as an encrypted package. In this example, if encrypted, content receiving component 312 can decrypt the encrypted package. In any case, signature verifying component 314 can obtain the signature from the signed content. In one example, signature verifying component 314 can decrypt the signature using a public key corresponding to the merchant (e.g., a key corresponding to the merchant device 102) to determine whether the signature is authentic and/or corresponds to the merchant. Verifying the signature, for example, can include comparing the decryption of the signature to the content to determine whether the decryption correlates to at least a portion of the content. In an example, the signature verifying component 314 compares the decryption to a hash of the content where the hash can be similar to the hash applied by the merchant device 102 that is encrypted with the private key to generate the signature. Thus, if the hash of the content matches the decrypted signature, the content can be verified as authentic.

Where the signature is verified as authentic by signature verifying component 314, content re-signing component 316 can automatically generate a signature for the content using a private key specific to the manufacturer, which allows manufacturer equipment to verify the manufacturer signature of the content as authentic before executing or presenting the content. Content re-signing component 316 can use a process similar to that of private key signing component 214 in generating the signature for the content using the private key of the manufacturer. Signed content delivering component 318 can provide the manufacturer signature and content, or a packaging of the signature and content, to merchant device 102 for use with manufacturer equipment. The automated signing performed by content re-signing component 316 is based on authenticating the merchant device 102 as the sender of the content, as described, which implies the merchant's approval of the content for use with the manufacturer equipment. The manufacturer equipment can use a process similar to signature verifying component 314 to verify the manufacturer signature as authentic using a public key accessible by the manufacturer equipment that corresponds to the private key used by content re-signing component 316 in generating the signature.

In one example, manufacturer server 104 can populate the repository of authenticated source keys 310 with keys provided to various merchant devices 102 (and/or public keys corresponding to private keys provided to the various merchant devices 102). For example, manufacturer server 104 can populate the repository 310 before or after deployment at the merchant, where the manufacturer provides merchants with the merchant devices. In another example, as described, merchant device 102 can generate its private key used to sign content, and can communicate a corresponding public key to manufacturer server 104. This can occur over a secure link using various encryptions, etc. In this example, manufacturer server 104 stores the public key in the repository of authenticated source keys 310 for later decrypting of signatures of signed content from the merchant device 102, as described. Thus, in one example, the signed content from merchant device 102 can include an identifier that associates the signature to the merchant device 102 to allow signature verifying component 314 to select the correct key from the repository of authenticated source keys 310 for decrypting the signature and verifying the signature as authentic where the signature verifying component 314 determines an identifier of the merchant device 102 (e.g., based on communication session information established with the merchant device 102).

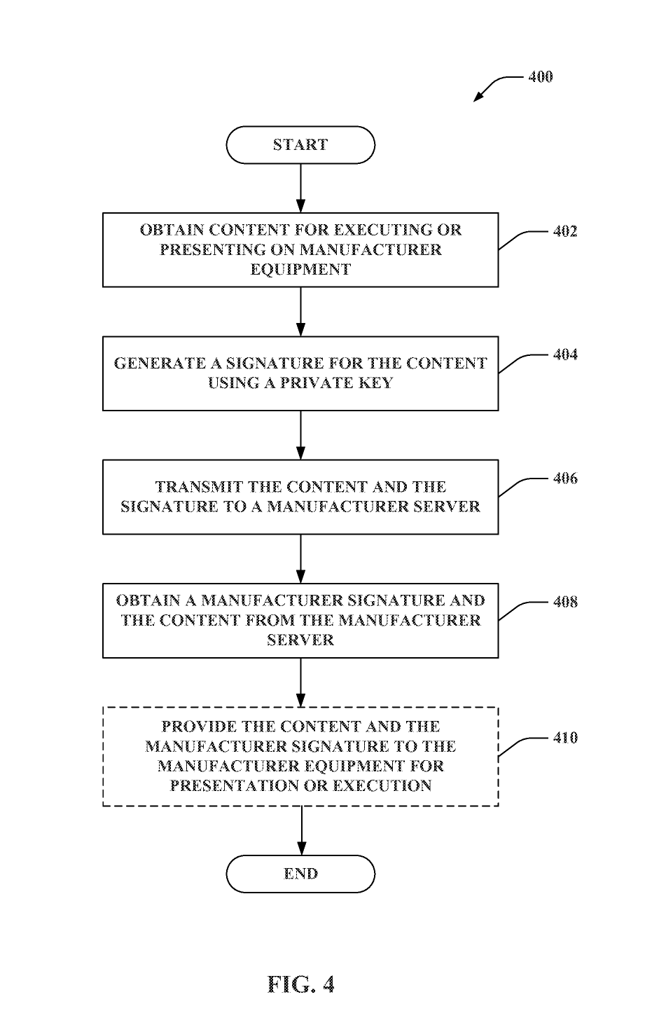

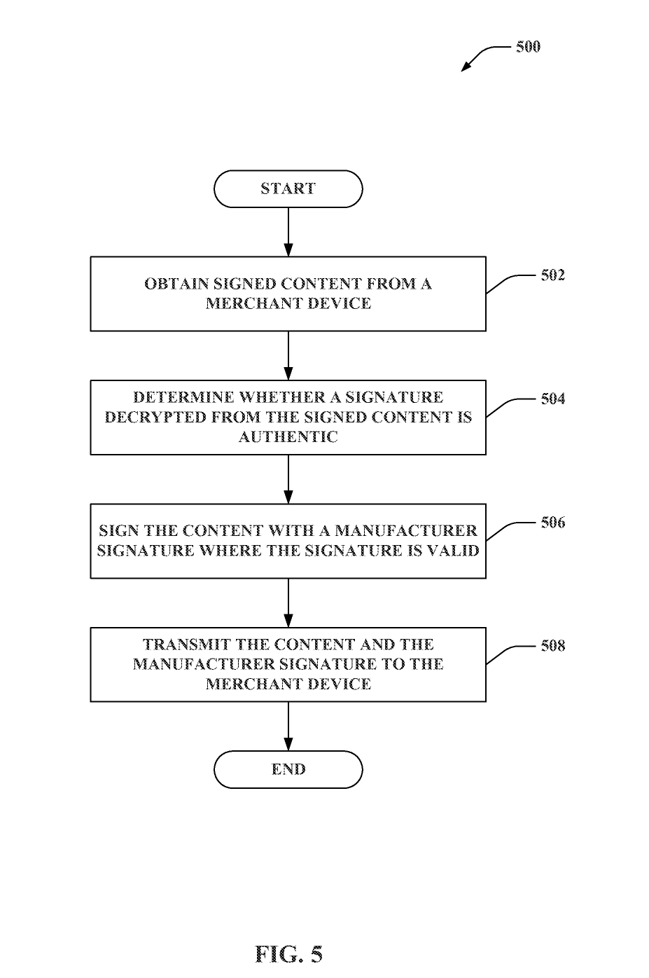

Referring to FIGS. 4 and 5, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 illustrates an example methodology 400 for receiving manufacturer-signed content for use with manufacturer equipment. At 402, content for executing or presenting on manufacturer equipment can be obtained. This can include receiving content from a remote source, storage device, etc. For example, the content can be downloaded by an authorized user for signing the content with a signature provided by a manufacturer of the equipment.

At 404, a signature for the content can be generated using a private key. The private key can be provisioned by the manufacturer and/or can be locally generated. In the latter case, the key, or a corresponding public key, can be provided to the manufacturer to allow authentication of the signature. At 406, the content and the signature are transmitted to a manufacturer server. As described, this can include transmitting a package including the content and signature (e.g., the signed content). Moreover, transmitting can include establishing a secure link with the manufacturer server, encrypting the content and/or signature, etc., and transmitting to the manufacturer server. Further, as described, the manufacturer server can be remotely located such that transmission occurs over one or more connections between various network devices.

At 408, a manufacturer signature and the content can be obtained from the manufacturer server. In this regard, the manufacturer server can re-sign the content using the manufacturer signature to allow verification of the manufacturer signature at manufacturer equipment prior to execution or presentation of the content. The re-signing can be automated at the manufacturer server based on verifying the merchant signature used to sign the content, as described. Moreover, as described, this can include verifying the identity of the merchant providing the content to determine which key to use for authenticating the merchant signature. At 410, the content and the manufacturer signature are optionally provided to the manufacturer equipment for presentation or execution. As described, the manufacturer equipment can verify the manufacturer signature (e.g., using a public key for the manufacturer) in determining whether to present or execute the content.

FIG. 5 illustrates an example methodology 500 for automatically signing content with a manufacturer signature where the content is from an authenticated merchant. At 502, signed content is obtained from a merchant device. For example, the content can have been signed using a signature generated from a private key which is known (or at least a corresponding public key is known) based on receiving the key and/or provisioning the key to the merchant device, as described.

At 504, it can be determined whether a signature decrypted from the signed content is authentic. For example, this can include decrypting the signature based on the known private or public key of the merchant device. If the signature is authenticated, the content can be re-signed with a manufacturer signature at 506. This can be an automated step (and indeed methodology 500 can be automated based on receiving the content), such that the merchant is responsible for ensuring the content provided is functional, secure, trustworthy, etc. In addition, as described, this can include signing the merchant-signed content, replacing the merchant signature with that of the manufacturer, etc. At 508, the content and the manufacturer signature are transmitted to the merchant device. This allows the merchant device to use the content with manufacturer equipment, as described, by uploading the manufacturer-signed content thereon. The manufacturer equipment can then verify authenticity of the manufacturer signature provided with the content before displaying or executing the content, as described.

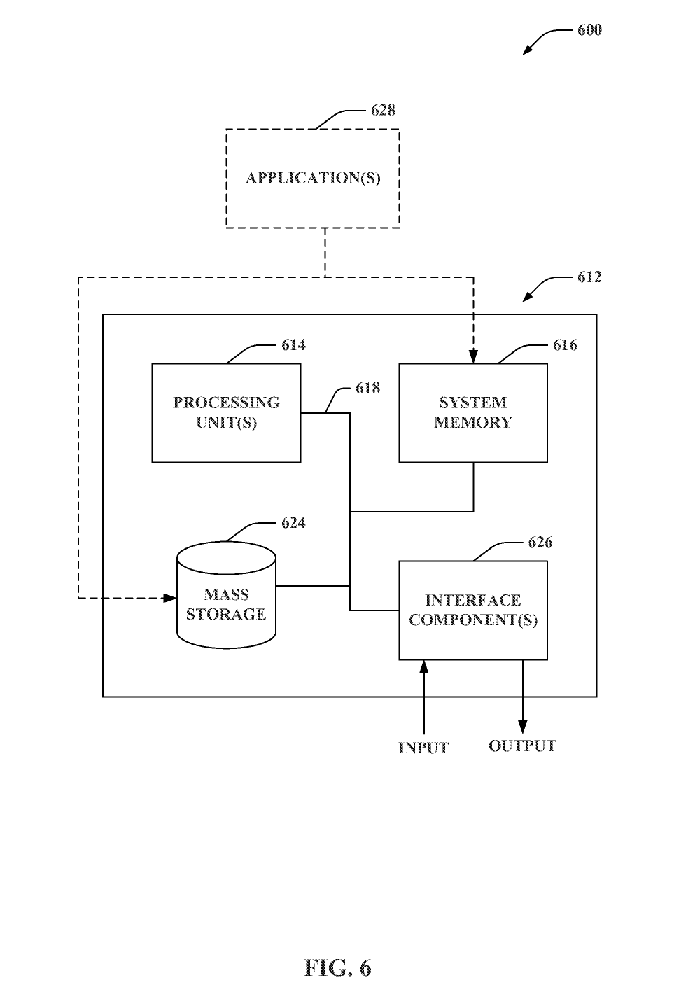

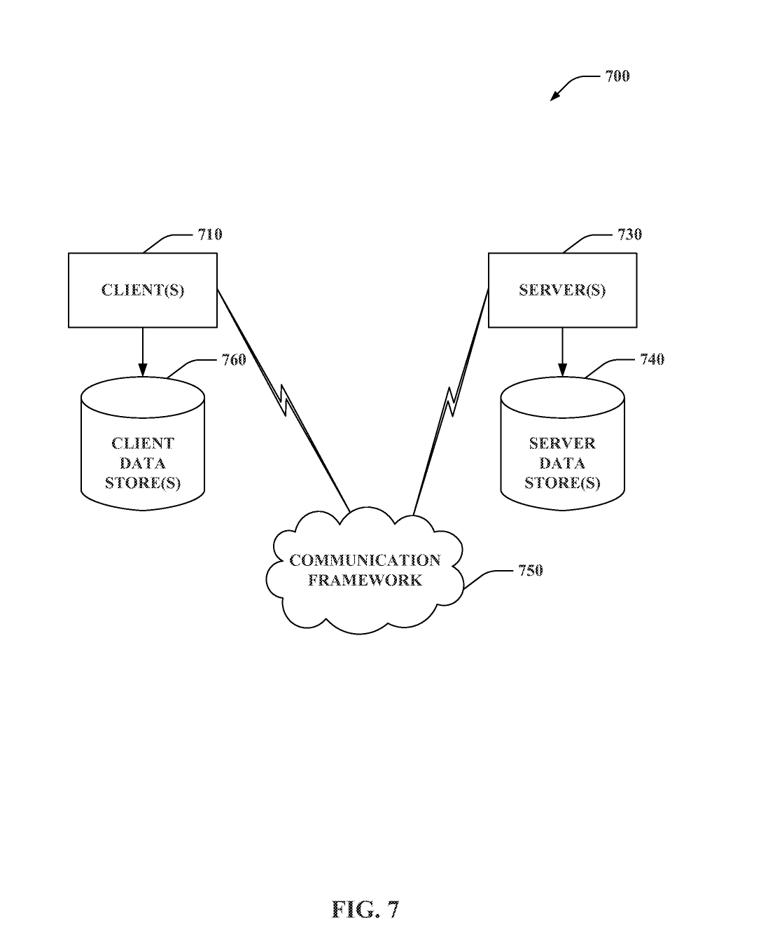

To provide a context for the various aspects of the disclosed subject matter, FIGS. 6 and 7 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 6, an exemplary environment 600 for implementing various aspects disclosed herein includes a computer 612 (e.g., desktop, laptop, server, hand held, programmable consumer or industrial electronics . . . ). The computer 612 includes a processing unit 614, a system memory 616 and a system bus 618. The system bus 618 couples system components including, but not limited to, the system memory 616 to the processing unit 614. The processing unit 614 can be any of various available microprocessors. It is to be appreciated that dual microprocessors, multi-core and other multiprocessor architectures can be employed as the processing unit 614.

The system memory 616 includes volatile and nonvolatile memory. The basic input/output system (BIOS), containing the basic routines to transfer information between elements within the computer 612, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 612 also includes removable/non-removable, volatile/non-volatile computer storage media. FIG. 6 illustrates, for example, mass storage 624. Mass storage 624 includes, but is not limited to, devices like a magnetic or optical disk drive, floppy disk drive, flash memory or memory stick. In addition, mass storage 624 can include storage media separately or in combination with other storage media.

FIG. 6 provides software application(s) 628 that act as an intermediary between users and/or other computers and the basic computer resources described in suitable operating environment 600. Such software application(s) 628 include one or both of system and application software. System software can include an operating system, which can be stored on mass storage 624, that acts to control and allocate resources of the computer system 612. Application software takes advantage of the management of resources by system software through program modules and data stored on either or both of system memory 616 and mass storage 624.

The computer 612 also includes one or more interface components 626 that are communicatively coupled to the bus 618 and facilitate interaction with the computer 612. By way of example, the interface component 626 can be a port (e.g., serial, parallel, PCMCIA, USB, FireWire . . . ) or an interface card (e.g., sound, video, network . . . ) or the like. The interface component 626 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 612 to output device(s) via interface component 626. Output devices can include displays (e.g., cathode ray tube (CRT), liquid crystal display (LCD), light emitting diode (LCD), plasma . . . ), speakers, printers and other computers, among other things.

According to an example, the processing unit(s) 614 can comprise or receive instructions related to signing content, verifying signatures of content, etc., and/or other aspects described herein. It is to be appreciated that the system memory 616 can additionally or alternatively house such instructions and the processing unit(s) 614 can be utilized to process the instructions. Moreover, interface component(s) 626 can allow for uploading content, as described, mass storage 624 can store authenticated source keys, etc. System 600, or at least computer 612, can include a merchant device 102, manufacturer server 104, etc., as described.

FIG. 7 is a schematic block diagram of a sample-computing environment 700 with which the subject innovation can interact. The environment 700 includes one or more client(s) 710. The client(s) 710 can be hardware and/or software (e.g., threads, processes, computing devices). The environment 700 also includes one or more server(s) 730. Thus, environment 700 can correspond to a two-tier client server model or a multi-tier model (e.g., client, middle tier server, data server), amongst other models. The server(s) 730 can also be hardware and/or software (e.g., threads, processes, computing devices). The servers 730 can house threads to perform transformations by employing the aspects of the subject innovation, for example. One possible communication between a client 710 and a server 730 may be in the form of a data packet transmitted between two or more computer processes.

The environment 700 includes a communication framework 750 that can be employed to facilitate communications between the client(s) 710 and the server(s) 730. Here, the client(s) 710 can correspond to program application components and the server(s) 730 can provide the functionality of the interface and optionally the storage system, as previously described. The client(s) 710 are operatively connected to one or more client data store(s) 760 that can be employed to store information local to the client(s) 710. Similarly, the server(s) 730 are operatively connected to one or more server data store(s) 740 that can be employed to store information local to the servers 730.

By way of example, one or more clients 710 can be merchant devices 102 requesting automated content signing from the server(s) 730, which can include a manufacturer server 104, via communication framework 750. The server(s) 730 can, in one example, sign content with a manufacturer signature based on determining the content is signed with an authentic merchant signature, as described, and can transmit the content and/or manufacturer signature back to the client(s) 710 via communication framework 750.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A system for obtaining manufacturer-signed content for use with manufacturer equipment in a fuel dispensing environment, comprising:
a content receiving component for obtaining content for executing or presenting on manufacturer equipment;
a private key signing component for generating a signature for the content based at least in part on a private key;
a signed content delivering component for transmitting the content and the signature to a manufacturer server; and
a signed content receiving component for obtaining a manufacturer signature and the content from the manufacturer server.

2. The system of claim 1, wherein the signed content receiving component provides the manufacturer signature and the content to manufacturer equipment for presenting or executing the content.

3. The system of claim 1, further comprising a key obtaining component for obtaining the private key.

4. The system of claim 3, wherein the key obtaining component generates the private key and communicates a corresponding public key to the manufacturer server.

5. The system of claim 3, wherein the key obtaining component authorizes a user providing the content prior to obtaining the private key.

6. The system of claim 5, wherein the key obtaining component authorizes the user based at least in part on an inserted chip card and a corresponding password entry.

7. The system of claim 1, wherein the signed content delivering component establishes a secure link with the manufacturer server based at least in part on a mutual public-key infrastructure authentication, and transmits the content and the signature over the secure link.

8. The system of claim 1, wherein the signed content delivering component transmits the content and the signature to the manufacturer server in an encrypted package.

9. The system of claim 1, further comprising anti-tampering electronics to detect tampering with the system and delete the private key where tampering is detected.

10. The system of claim 1, wherein the content is an application or a service.

11. The system of claim 1, wherein the content receiving component obtains the content from a remote source or a removable storage device.

12. A method for obtaining manufacturer-signed content for use with manufacturer equipment in a fuel dispensing environment, comprising:
obtaining, using processing circuitry, content for executing or presenting on manufacturer equipment;
generating a signature for the content based at least in part on a private key;
transmitting the content and the signature to a manufacturer server; and
obtaining a manufacturer signature and the content from the manufacturer server in response to transmitting the content and the signature to the manufacturer server.

13. The method of claim 12, further comprising providing the manufacturer signature and the content to manufacturer equipment for presenting or executing the content.

14. The method of claim 12, further comprising generating the private key and communicating a corresponding public key to the manufacturer server.

15. The method of claim 14, further comprising authorizing a user to provide the content prior to obtaining the private key.

16. The method of claim 15, wherein the authorizing the user is based at least in part on an inserted chip card and a corresponding password entry.

17. The method of claim 12, further comprising establishing a secure link with the manufacturer server based at least in part on a mutual public-key infrastructure authentication, wherein the transmitting the content and the signature comprises using the secure link.

18. The method of claim 12, wherein the transmitting the content and the signature to the manufacturer server comprises transmitting the content and signature in an encrypted package.

19. The method of claim 12, wherein the obtaining the content comprises obtaining the content from a remote source or a removable storage device.

20. A system for automatically signing content received from an authenticated merchant in a fuel dispensing environment, comprising:
a content receiving component for obtaining signed content from a merchant device;
a signature verifying component for determining whether a signature decrypted from the signed content is authentic;
a content re-signing component for signing the content with a manufacturer signature where the signature is authentic; and
a signed content delivering component for transmitting the content and the manufacturer signature to the merchant device.

21. The system of claim 20, further comprising a repository of authenticated source keys, wherein the signature verifying component decrypts the signature from the signed content based at least in part on identifying a key from the repository of authenticated source keys that corresponds to the merchant device.

22. The system of claim 21, wherein the signature verifying component determines an identity of the merchant device from the signed content and determines the key based at least in part on the identity.

23. The system of claim 20, wherein the content receiving component establishes a secure link with the merchant device and obtains the signed content over the secure link.

24. The system of claim 23, wherein the signature verifying component determines an identity of the merchant device based on the secure link, and obtains a key for decrypting the signature based at least in part on the identity of the merchant device.

25. A method for automatically signing content received from an authenticated merchant in a fuel dispensing environment, comprising:
obtaining signed content from a merchant device;
decrypting a signature obtained with the signed content;
determining, using processing circuitry, whether the decrypted signature is authentic;
signing the content with a manufacturer signature where the signature is authentic; and
transmitting the content and the manufacturer signature to the merchant device.

26. The method of claim 25, further comprising identifying a key from a repository of authenticated source keys that corresponds to the merchant device, wherein the decrypting the signature is based at least in part on the key.

27. The method of claim 26, further comprising determining an identity of the merchant device from the signed content, wherein the identifying the key is further based at least in part on the identity.

28. The method of claim 25, further comprising establishing a secure link with the merchant device, wherein the obtaining the signed content is over the secure link.

29. The method of claim 28, further comprising determining an identity of the merchant device based on the secure link, and obtaining a key for decrypting the signature based at least in part on the identity of the merchant device.
